(19) United States
(12) Patent Application Publication
(10) Pub. No.: US 2013/0238103 A1
(43) Pub. Date: Sep. 12, 2013

(54) MACHINE MANAGEMENT SYSTEM

(71) Applicant: FANUC CORPORATION, Yamanashi (JP)

(72) Inventor: Masanobu TAKEMOTO, Minamitsuru-gun (JP)

(73) Assignee: FANUC CORPORATION, Yamanashi (JP)

(21) Appl. No.: 13/726,305

(22) Filed: Dec. 24, 2012

(30) Foreign Application Priority Data
Mar. 8, 2012 (JP) 2012-052040

(51) Int. Cl. G05B 15/02

(52) U.S. Cl. CPC G05B 15/02
USPC 700/83

(57) ABSTRACT

A machine management system is constructed by connecting machine tools to a computer through a network. ID information of a machine tool is acquired, and whether or not there is display data matching the acquired ID on the computer is checked. When there is such display data, after an event occurs, the display data on the side of the computer is compared with the display data on the side of the machine tool. When it is found, as a result of the comparison, that the display data on the side of the computer is not identical to the display data on the side of the machine tool, the display data is transferred from the machine tool to the computer and is stored.

### BACKGROUND OF THE INVENTION

1. Field of the Invention

The present invention relates to a machine tool management system which connects a computer and a plurality of machines through a network.

2. Description of the Related Art

Devices are generally known which monitor operation states of machine tools by means of a computer using a management system which connects the computer and a plurality of machine tools through a network.

Data processed by this management system includes:

[A] State data: data which changes according to a state of a machine tool; and

[B] Display data: data which is unique irrespectively of a state of a machine tool.

The state data is, for example, an operation state of the machine tool (indicating that a machine tool is operating or stops) or a number for an alarm which is currently set off. This data is sent from a machine tool to a computer which manages the machine tool through a network cyclically or at an arbitrary timing.

The display data is, for example, an alarm message file of a machine tool which is displayed on a computer which is connected with the machine tool through the network. This display data is generally registered in a storage device of a computer when management system software is installed in the computer.

Usage of state data and display data will be described using the following examples.

When an alarm is set off in a machine tool, an alarm number (state data) is notified from the machine tool to a computer through a network. The computer searches for a corresponding message from an alarm message file (display data) stored in the computer in advance using the sent alarm number (state data) as a keyword, and displays the searched message on a screen.

When there is a model change or a minor change of machine tools, outlooks of the machine tools change, or alarm messages are changed or added, that is, display data is changed in some cases. When this new machine tool is connected to the above management system, it is not possible to display, for example, an alarm message of the new machine tool on the computer, because display data of the new machine tool has not been registered in the computer connected through the network.

In order to solve this problem, it is necessary to improve management system software to be installed in a computer, and further install the improved software in the computer connected to a machine tool through a network. To do this, time and cost to improve software are required, and labor for installing the software in the computer is required.

Japanese Patent Application Laid-Open No. 2009-119616 discloses a method as another solution method. Even when a new machine tool (injection molding machine) of which display data (error master file) is changed is connected to a management system, it is possible to support the changed display data by using this method without changing software of a computer connected to the machine tool through a network.

However, the method disclosed in Japanese Patent Application Laid-Open No. 2009-119616 mentioned above requires that a machine tool (injection molding machine) connected to the management system should have compatibility. Even if alarm numbers of a machine tool manufactured by a given manufacturer and a machine tool manufactured by another manufacturer happen to be the same, contents indicated by the alarms are not necessarily the same. For example, alarm number 1000 of a machine tool manufactured by company A may indicate “limit switch abnormality”, while alarm number 1000 of a machine tool manufactured by company B may be “coolant abnormality”. However, only one message corresponding to alarm number 1000 can be prepared in an alarm message file (error master file) disclosed in Japanese Patent Application Laid-Open No. 2009-119616 mentioned above, and therefore it is not possible to switch a message between the machine tools manufactured by company A and company B.

### SUMMARY OF THE INVENTION

In light of the problem of the conventional technique as described above, it is therefore an object of the present invention to provide a machine management system which connects a computer and machines through a network and which can be used without changing software of the computer when a new machine is connected to the management system.

A machine management system according to the present invention connects a computer and a plurality of machines with each other through a network, and the computer has: a state data acquiring unit which acquires state data which changes according to a state of the machine; a first display data storage unit which stores display data of the machine; a display data selecting unit which selects the display data of the machine matching the state data acquired by the state data acquiring unit, from among display data of machines stored in the display data storage unit; and a data display unit which displays the display data selected by the display data selecting unit. The machine comprises: a second display data storage unit which stores the display data of the machine; and a display data transferring unit which transfers to the computer the display data stored in the second display data storage unit. The computer further comprises: an ID information acquiring unit which acquires, when a machine is connected, ID information of the machine; and a display data checking unit which checks whether or not the display data matching the ID information acquired by the ID information acquiring unit is stored in the first display data storage unit, and when there is no display data, the computer acquires the display data from the machine, and associates the acquired display data with the ID information and store the data in the first display data storage unit.

The machine management system may further comprise a display data comparing unit which compares the display data of the machine stored in the first display data storage unit and the display data of the machine stored in the second display data storage unit, wherein, when any display data is stored in the first display data storage unit and if it is decided, as a result of comparing by the display data comparing unit, that the display data of the machine stored in the first display data storage unit is not identical to the display data of the machine stored in the second display data storage unit, then the display data is acquired from the machine and the acquired display data is associated with the ID information to be updated and is stored in the first display data storage unit.

The present invention can provide a machine management system which connects a computer and machines through a network and which can be used without changing software of the computer when a new machine is connected to the management system.

### BRIEF DESCRIPTION OF THE DRAWINGS

The above and other objects and features of the present invention will become clear from the following description of an embodiment with reference to the accompanying drawings. Among these drawings:

FIG. 1 is a schematic diagram of a general machine tool management system;

FIG. 2 is a schematic diagram of a machine tool controller;

FIG. 3 is a view for explaining display data stored in a computer connected through a network;

FIG. 4 is a flowchart illustrating processing of updating display data on the side of a computer connected through the network; and

FIG. 5 is a flowchart illustrating processing of displaying an alarm set off in a machine tool, on a display screen of the computer, as an example of use of display data and state data.

### DETAILED DESCRIPTION OF THE PREFERRED EMBODIMENTS

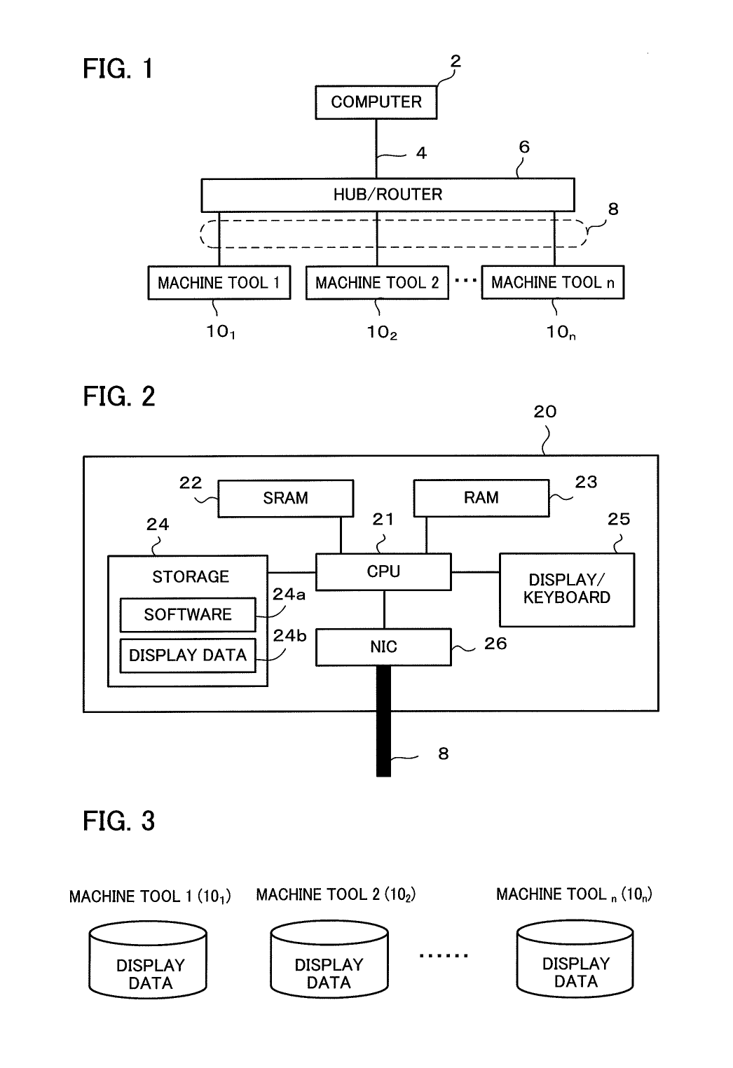

First, a general machine tool management system will be schematically described using FIG. 1.

A plurality of machine tools (a first machine tool 10₁, a second machine tool 10₂, . . . , and an n-th machine tool 10ₙ) are connected through Ethernet (registered trademark) 8, a HUB/router 6 and Ethernet (registered trademark) 4 to a computer 2 which manages machine tools. The computer 2 has an interface which transmits and receives data to and from a plurality of machine tools through a network, a computation processing function which performs various computation processing and a storage unit which stores various data. For example, a basic LAN is used for connection as a network connecting unit. Note that, with the present invention, the network connecting unit is not limited to the LAN.

Next, a machine tool controller will be schematically described using FIG. 2. Although, for example, a basic LAN is used for connection as the network connecting unit, the network connecting unit is by no means limited in the present invention.

A controller 20 which controls machine tools has a CPU 21 which performs computation processing, a RAM 23 which temporarily stores various data, a NIC (Network Interface Card) 26 which is an interface for connecting with an external device through the network, and a storage 24 which stores software. In this storage 24, a flash memory or a hard disk is used, and software 24a and display data 24b are stored. A SRAM 22 is a hold-type memory backed up by, for example, a battery, and IDs for identifying machine tools connected through the network are registered therein. Note that, with a machine tool controller on which the SRAM 22 is not mounted, IDs for identifying machine tools are registered in the storage 24. An ID for identifying a machine tool can be input using a display keyboard 25 mounted on the controller 20.

A feature of the present invention lies in that display data for the management system is stored in the storage 24 of the controller 20 in FIG. 2. This display data is handled together with machine tool controlling software or alone, and, when the number of alarms mounted upon upgrading of the machine tool controlling software increases, display data is also updated likewise.

Next, display data stored in the computer connected through the network will be described using FIG. 3.

FIG. 3 illustrates an example where display data is registered in each of the machine tools 10₁, 10₂, . . . , and 10ₙ connected through the network. Alternatively, when a plurality of machine tools belonging to the same type share display data, this display data may be registered in association with the type of the machine tools, instead of being registered in association with individual machine tools.

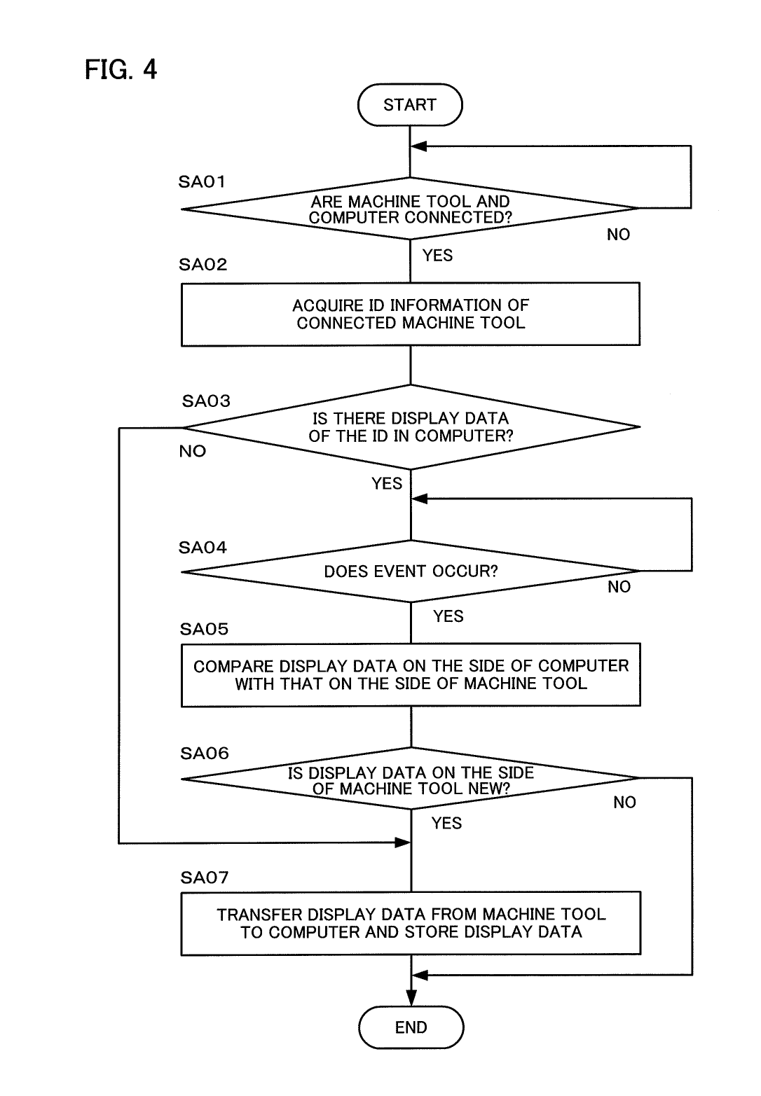

Processing of updating display data of the computer connected through the network will be described using a flowchart of FIG. 4.

When the computer 2 and a machine tool are connected through the network (step SA01), ID information of the connected machine tool is acquired first (step SA02). This ID information is used for classification of display data. When, for example, individual IDs are set to the machine tools 10₁, 10₂, . . . , and 10ₙ, display data is registered in the computer 2 for every machine tool. Further, when an ID “AAA” is set to the machine tools 10₁ and 10₂ and an ID “BBB” is set to a machine tool 10₃, display data of the machine tool 10₁ and display data of the machine tool 10₂ are registered and managed as common display data.

Next, whether or not there is display data matching the acquired ID on the side of the computer 2 is checked (step SA03). When there is no corresponding display data, that is, the machine tool is connected through the network for the first time, display data of the machine tool is transferred from the machine tool to the computer and stored in the computer (step SA07). The display data transferred to the computer is associated with the acquired ID information, and is stored in the computer.

On the other hand, when there is display data matching the acquired ID (that is, if display data matching the acquired ID is display data from the machine tool that has been connected through the network in the past), an event of the display data update is waited (step SA04). This event may proceed to the next step by a manual operation by an operator on the computer or the machine tool or automatically without such an operation by the operator.

Then, display data on the side of the computer and display data on the side of the machine tool are compared with each other (step SA05). When determined that display data on the side of the machine tool is new as a result of the comparison (step SA06), display data on the side of the computer is updated by transferring the display data acquired in step SA02 from the machine tool to the computer and storing the display data in the computer (step SA07). The updated display data is associated with ID information and stored in the computer. It is possible to decide whether display data of the machine tool is new or not, based on version information of the display data, or the like. Note that, although, in processing illustrated by the flowchart in FIG. 4, immediately after a machine tool and the computer are connected with each other through the network, ID information of the machine tool is automatically acquired, this ID information need not be acquired immediately after the machine tool and the computer are connected with each other through the network, and the ID information may also be acquired after an operator performs an operation.

Similarly, checking of whether or not there is display data matching an acquired ID in the computer and updating of display data on the side of the computer may also be performed after an operator performs an operation.

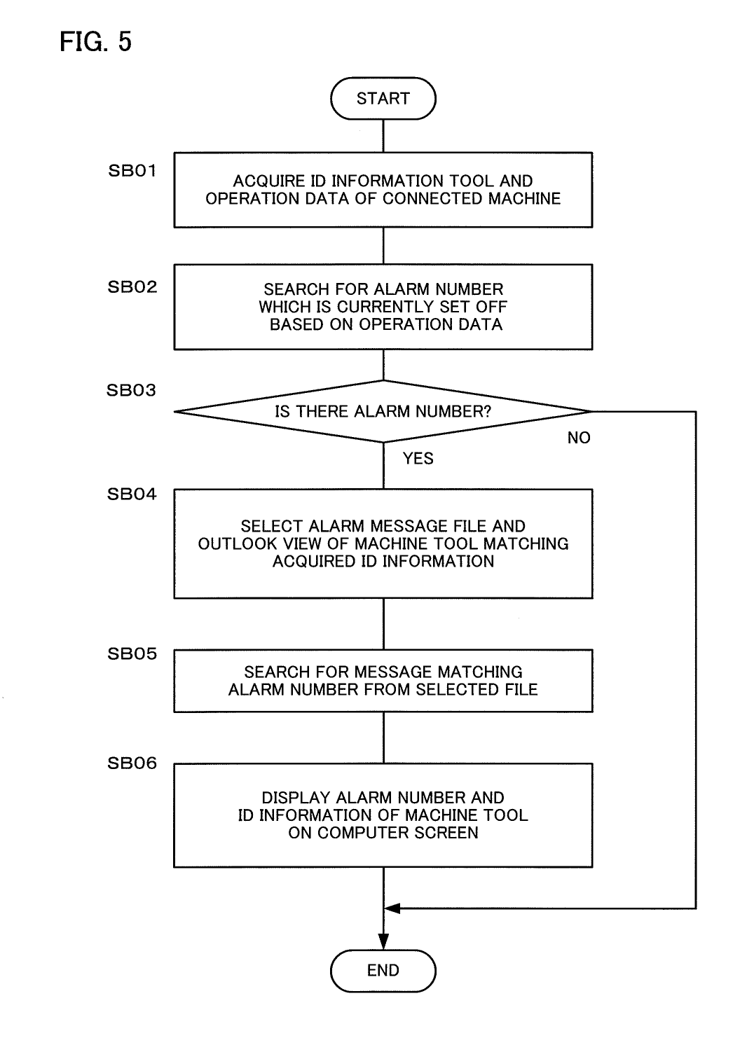

Next, processing of displaying an alarm set off in a machine tool on a display screen of the computer will be described using the flowchart of FIG. 5 as an example of use of display data and state data.

First, the computer 2 acquires ID information and operation data (state data) from a machine tool connected with the computer 2 (step SB01). Further, by analyzing the acquired operation data (step SB02), whether or not an alarm is set off in the machine tool connected with the computer 2 is checked (step SB03). With this example, when an alarm is set off in the machine tool, a number for the alarm which is set off is included in operation data, and on the other hand, when an alarm is not set off, an alarm number is not included in the operation data.

When the alarm number is found in the operation data, the computer selects an alarm message file (display data) and an outlook view of the machine tool based on the acquired ID information of the machine tool (step SB04). Further, a message matching the alarm number detected in step SB02 is searched for from the selected alarm message file (display data) (step SB05). After the message is searched for, the alarm number, the alarm message and the ID information of the machine tool are displayed on the computer screen. Such displays make it possible to check on the computer what alarm is set off in which machine tool now. Note that, an outlook view of a machine tool in which an alarm is set off may be displayed on the computer screen in addition to these displays.

The computer 2 executes the processing of the flowchart illustrated in FIG. 5 with respect to all connected machine tools cyclically or at a specific timing. Note that, display data displayed on the computer screen may be not only an alarm message (text data) but also image data such as an icon.

When a new machine tool is connected to the machine tool management system according to the present invention through the network, display data on the side of the machine tool is registered on the side of the computer automatically or by an operator's operation. Further, when a machine tool connected to the computer through the network is upgraded, new display data is registered on the side of the computer automatically or by an operator's operation. Consequently, it is possible to use the management system without changing software of the computer.

Note that, although the machine tool management system such as a multispindle processing machine has been described as an embodiment of the machine management system according to the present invention, the present invention is also applicable to a management system of a machine (injection molding machine) which connects multiple injection molding machines to a computer through a network.

1. A machine management system in which a computer and a plurality of machines are connected with each other through a network, wherein the computer comprises:
a state data acquiring unit which acquires state data which changes according to a state of the machine;
a first display data storage unit which stores display data of the machine;
a display data selecting unit which selects the display data of the machine matching the state data acquired by the state data acquiring unit, from among display data of machines stored in the display data storage unit; and
a data display unit which displays the display data selected by the display data selecting unit,
wherein the machine comprises:
a second display data storage unit which stores the display data of the machine; and
a display data transferring unit which transfers to the computer the display data stored in the second display data storage unit,
wherein the computer further comprises:
an ID information acquiring unit which acquires, when a machine is connected, ID information of the machine; and
a display data checking unit which checks whether or not the display data matching the ID information acquired by the ID information acquiring unit is stored in the first display data storage unit, and when there is no display data, the computer acquires the display data from the machine, and associates the acquired display data with the ID information and store the data in the first display data storage unit.

2. The machine management system according to claim 1, further comprising a display data comparing unit which compares the display data of the machine stored in the first display data storage unit and the display data of the machine stored in the second display data storage unit,
when any display data is stored in the first display data storage unit and if it is decided, as a result of comparing by the display data comparing unit, that the display data of the machine stored in the first display data storage unit is not identical to the display data of the machine stored in the second display data storage unit, then the display data is acquired from the machine and the acquired display data is associated with the ID information to be updated and is stored in the first display data storage unit.
